(19) United States
(12) Patent Application Publication
(10) Pub. No.: US 2011/0084985 A1
(43) Pub. Date: Apr. 14, 2011

(54) INPUT APPARATUS, DISPLAY APPARATUS HAVING AN INPUT FUNCTION, INPUT METHOD, AND METHOD OF CONTROLLING A DISPLAY APPARATUS HAVING AN INPUT FUNCTION

(75) Inventor: Tomohiko Kojima, Nagano (JP)

(73) Assignee: SONY CORPORATION, Tokyo (JP)

(21) Appl. No.: 12/899,964

(22) Filed: Oct. 7, 2010

(30) Foreign Application Priority Data
Oct. 14, 2009 (JP) P2009-237004

(51) Int. Cl. G06F 3/041; G09G 5/00

(52) U.S. Cl. 345/650; 345/173

(57) ABSTRACT

An input apparatus having an input surface touched by an object body at input time, the input apparatus includes: when a contact area of the object body on the input surface increases, an increase-direction detection section generating increase-direction information corresponding to the increase direction of the contact area; and when the contact area of the object body on the input surface is moved, a movement-direction detection section generating movement-direction information corresponding to the movement direction of the contact area.

### CROSS REFERENCES TO RELATED APPLICATIONS

The present application claims priority to Japanese Priority Patent Application JP 2009-237004 filed in the Japan Patent Office on Oct. 14, 2009, the entire content of which is hereby incorporated by reference.

### BACKGROUND

The present application relates to an input apparatus, display apparatus having an input function, input method, and method of controlling a display apparatus having an input function.

In recent years, in electronic devices, such as a mobile telephone, personal digital assistants (PDA), etc., a display apparatus having an input function, in which an input apparatus (touch panel) is disposed to overlap an image display apparatus, such as a liquid crystal apparatus, etc., is used. In such a display apparatus having an input function, when a user touches with his/her finger or moves his/her finger close to an input surface (image display area) while watching an image displayed by an image forming apparatus, the user is allowed to input information corresponding to a position of the finger. Also, in a display apparatus having an input function, a technique for inputting by relative movements of two fingers has been proposed in U.S. Patent Application Publication No. 2008/0180405.

### SUMMARY

However, in an input apparatus described in the Patent Document US2008/0180405A1, it is necessary to use two fingers, and thus the apparatus is inconvenient. For example, in the case of a mobile electronic device, in order to move two fingers relatively on the input surface, it is necessary to hold the electronic device with one hand, and to perform input operation by fingers of the other hand, and thus the user is not allowed to use the electronic device with one hand.

In view of these circumstances, it is desirable to provide an input apparatus, display apparatus having an input function, input method, and a method of controlling a display apparatus having an input function, which allows the user to input a plurality of pieces of information by easy operation with one finger.

According to an embodiment, there is provided an input apparatus having an input surface touched by an object body at input time, the input apparatus including: when a contact area of the object body on the input surface increases, an increase-direction detection section generating increase-direction information corresponding to the increase direction of the contact area; and when the contact area of the object body on the input surface is moved, a movement-direction detection section generating movement-direction information corresponding to the movement direction of the contact area.

Also, according to another embodiment, there is provided a method of inputting in an input apparatus having an input surface touched by an object body at input time, the method including the steps of: when a contact area of the object body on the input surface increases, generating increase-direction information corresponding to the increase direction of the contact area; and when a contact area of the object body on the input surface is moved, generating movement-direction information corresponding to the movement direction of the contact area.

In an embodiment, when the contact area of an object body on the input surface increases, increase-direction information is generated, and when the contact area of the object body on the input surface moves, movement-direction information is generated, and thus it is possible to use the increase-direction information and the movement-direction information as input information. Either of such input can be carried out, for example by one finger as an object body, and thus input operation is easy. Accordingly, for example, there is an advantage in that in a state of holding an electronic device with one hand, the user is allowed to input with a finger of the hand holding the electronic device, etc.

According to another embodiment, there is provided a display apparatus having an input function, including: the input apparatus to which the present application is applied; an image display apparatus displaying an image in an image display area; and a control section controlling the image display apparatus on the basis of the increase-direction information and the movement-direction information to rotate the image currently displayed in the image display area, wherein the control section sets an extending direction of a rotational axis at the time of rotating the image on the basis of the increase-direction information, and if determined that the movement direction intersects the increase direction on the basis of the movement-direction information, the control section rotates the image about the rotational axis in a direction corresponding to the movement direction.

Also, according to another embodiment, there is provided a method of controlling a display apparatus having an input function changing a display mode of the image on the basis of the method of inputting according to the present application, wherein an extending direction of a rotational axis at the time of rotating the image is set on the basis of the increase-direction information, and if determined that the movement direction intersects the increase direction of the contact area in the movement-direction information, the image is rotated about the rotational axis in a direction corresponding to the movement direction.

With this arrangement, it is possible to rotate an image only by changing a contact state of an object body, such as a finger, etc., on an input surface while watching the image. Accordingly, it is possible to change states, for example, between a state of displaying a front side of a commercial product and a state of displaying a back side of the commercial product by easy operation.

In an embodiment, the image display apparatus can employ a configuration including the image display area in either an area overlapping the input surface as a plane or an area not overlapping the input surface as a plane. Among these configurations, if the image display area is disposed in an area not overlapping the input surface as a plane, the input apparatus is used as a mouse.

In an embodiment, the image display apparatus preferably includes the image display area in an area overlapping the input surface as a plane. With this arrangement, the user is allowed to perform input operation while watching an image displayed in the image display area.

In an embodiment, when the control section determines that the movement direction is the same as the increase direction in the movement-direction information, the control section preferably moves the rotational axis to a position corresponding to the movement direction in a direction intersecting the rotational axis. With this arrangement, it is possible to change a position of a rotational axis by simple operation.

In an embodiment, the input apparatus preferably includes a contact-area detection section detecting a contact area of the object body on the input surface, and generating contact-area information corresponding to the contact area, and the control section preferably resets a rotational condition of the image if the contact area is not larger than a threshold value after the contact area increases. With this arrangement, it is possible to rest the condition by simple operation.

In an embodiment, the image display apparatus preferably displays the rotational axis determined by the control section in the image display area. With this arrangement, it is possible to easily check the position of the rotational axis.

In an embodiment, when setting the rotational axis on the basis of the increase-direction information, for example, the control section may set the rotational axis at a position passing through the image.

In an embodiment, when setting the rotational axis on the basis of the increase-direction information, if two of the images are displayed in the image display area, the control section may set the rotational axis at a center of the two images. With this arrangement, two images can be rotated at the same time, and the two images are displayed at proper positions after the rotation.

In an embodiment, the input apparatus may include a contact-position detection section detecting a contact position of the object body on the input surface, and generating contact-position information corresponding to the contact position, and when setting the rotational axis on the basis of the increase-direction information, the control section may set the rotational axis at a position corresponding to the contact position. With this arrangement, it is possible to set the rotational axis at any position by simple operation.

Additional features and advantages are described herein, and will be apparent from the following Detailed Description and the figures.

### BRIEF DESCRIPTION OF THE FIGURES

FIGS. 1A and 1B are explanatory diagrams schematically illustrating a configuration of a display apparatus having an input function according to an embodiment;

FIGS. 2A, 2B, and 2C are explanatory diagrams schematically illustrating a state in which input and image display are carried out in the display apparatus having an input function according to an embodiment;

FIG. 3 is an explanatory diagram illustrating an electrical configuration of the display apparatus having an input function according to an embodiment;

FIG. 4 is a flowchart illustrating control contents at the time of rotating an image by input operation on an input surface in the display apparatus having an input function according to an embodiment;

FIGS. 5A, 5B, and 5C are explanatory diagrams illustrating input operation on an input surface and an image displayed in an image display area in the display apparatus having an input function according to an embodiment;

FIGS. 6A and 6B are explanatory diagrams illustrating input operation on an input surface and an image displayed in an image display area in the display apparatus having an input function according to an embodiment;

FIG. 7 is an explanatory diagram in the case where an increase direction of a contact area of an object body on an input surface is inclined in the display apparatus having an input function according to an embodiment;

FIG. 8 is an explanatory diagram illustrating another method of setting a rotational axis in the display apparatus having an input function according to an embodiment;

FIG. 9 is an explanatory diagram still another method of setting a rotational axis in the display apparatus having an input function according to an embodiment; and

FIGS. 10A, 10B, and 10C are explanatory diagrams of an electronic device provided with the display apparatus having an input function according to an embodiment.

### DETAILED DESCRIPTION

The present application will be described in detail below with reference to the drawings according to an embodiment.

Overall Configuration

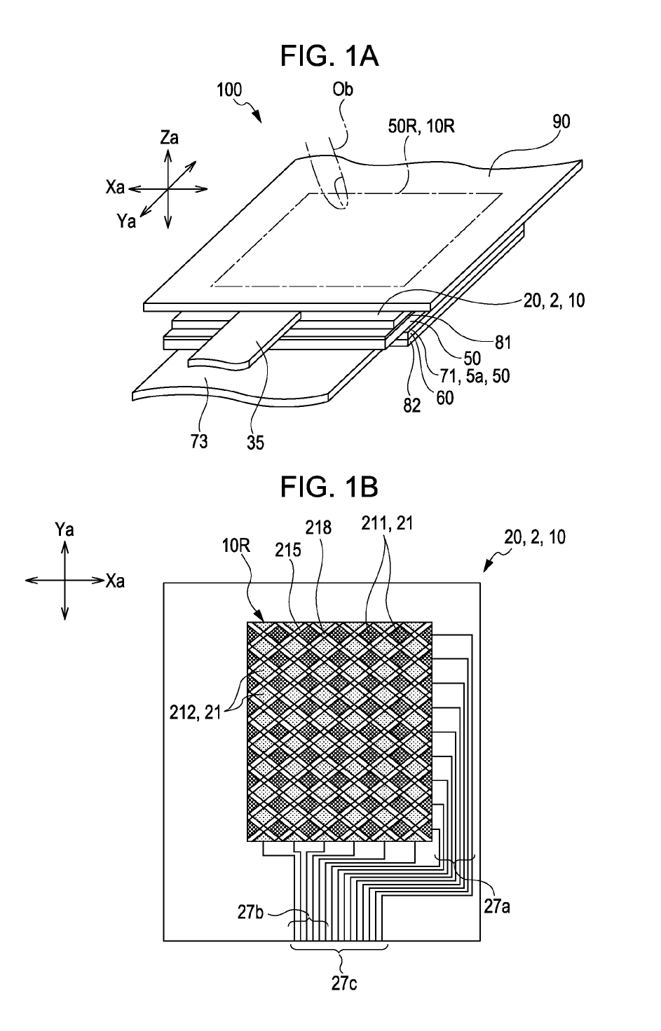

FIG. 1 is an explanatory diagram schematically illustrating a configuration of a display apparatus having an input function, to which the present application is applied. FIGS. 1A and 1B are explanatory diagrams of a display apparatus having an input function, and an input surface used for the display apparatus having an input function, respectively.

In FIG. 1A, the display apparatus having an input function 100, according to the present embodiment, has an image display apparatus 50 including an electro-optical panel 5 formed by a liquid crystal panel, an input apparatus 10 including an input panel 2 (touch panel) disposed in overlapping relation with an emission side of display light on the electro-optical panel 5, and a plastic cover 90 disposed in overlapping relation with a side on which input operation is carried out on the input panel 2.

The input apparatus 10 is a touch panel of a capacitive type, or an optical type, or an electromagnetic induction type, etc. Such a touch panel can detect an input position by non-contact operation. However, in the input apparatus 10 according to the present embodiment, when an object body Ob, such as a finger, etc., touches an input surface 10R, a contact state of the object body on the input surface 10R and a change of a contact state are detected, and the detection result is regarded as input information. That is to say, in the input, apparatus 10 of a capacitive type, when an object body Ob comes close, capacitance coupled to a position-detection electrode of a position to which the object body Ob has come close increases, and thus the object body Ob is allowed to come close. Also, when the object body Ob touches the input surface 10R, capacitance coupled to the position-detection electrode corresponding to the position touched by the object body Ob increases, and thus it is possible to detect a contact area of the object body Ob.

In the present embodiment, the input panel 2 and the electro-optical panel 5 both have a rectangular and planar shape, and a central area of the input panel 2 in a plan view is the input surface 10R. Also, on the electro-optical panel 5, an area that overlaps the input surface 10R on the input panel 2 in a plan view is an image display area 50R. The electro-optical panel 5 is an active-matrix liquid-crystal panel of a transmissive type or a semi-transmissive reflective type. A back-light device (not shown in the figure) is disposed on the opposite side (the opposite side to the emission side of display light) to the side of the electro-optical panel 5, on which the input panel 2 is disposed. The back-light device includes, for example, a translucent light-guiding plate disposed against the electro-optical panel 5 and a light source, such as a light-emitting diode emitting white light, etc., toward a side-edge section of the light-guiding plate. The light emitted from the light source enters into the side-edge section of the light-guiding plate, propagates in the light-guiding plate, and is emitted toward the electro-optical panel 5. A sheet-shaped optical member, such as a light-scattering sheet, a prism sheet, etc., is sometimes disposed between the light-guiding plate and the electro-optical panel 5. A first polarization plate 81 is laid on the display-light emission side of the electro-optical panel 5, and a second polarization plate 82 is laid on the other side.

The electro-optical panel 5 includes a translucent device substrate 55 disposed at the display-light emission side and a translucent opposing substrate 60 disposed opposite to the device substrate 55. The opposing substrate 60 and the device substrate 55 are bonded by a rectangular sealing material 71, and a liquid crystal layer (not shown in the figure) is held in an area enclosed by the sealing material 71 between the opposing substrate 60 and the device substrate 55. Although omitted to be shown in the figure, on the device substrate 55, a plurality of pixel electrodes are formed by a translucent conductive film, such as an ITO (Indium Tin Oxide) film, etc., on a surface opposed to the opposing substrate 60. On the opposing substrate 60, a common electrode is formed by a translucent conductive film, such as an ITO film, etc., on the surface opposed to the device substrate 55. In this regard, if the electro-optical panel 5 is an IPS (In Plane Switching) type or an FFS (Fringe Field Switching) type, the common electrode is disposed on the side of the device substrate 55. Also, the opposing substrate 60 may be disposed at the display-light emission side. A flexible printed circuit 73 is connected to the device substrate 55, and a flexible printed circuit 35 is connected to the input panel 2.

Example of Configuration of Input Panel 2

The input apparatus 10 according to the present embodiment is, for example, a capacitive touch panel. And as shown in FIG. 1B, a plurality of input-position detection electrodes 21 are formed inside of an input surface 10R of a glass substrate 20, for example. The input-position detection electrode 21 includes a plurality of columns of first translucent electrode patterns 211 extending in a first direction (Y-axis direction Ya) and a plurality of columns of second translucent electrode patterns 212 extending in a second direction (X-axis direction Xa) intersecting the first direction. The first translucent electrode patterns 211 and the second translucent electrode patterns 212 are formed by a first conductive film, such as an ITO film, etc. In the present embodiment, the first translucent electrode patterns 211 and the second translucent electrode patterns 212 are formed on a same layer on a same plane of the glass substrate 20. Accordingly, the glass substrate 20 includes a plurality of intersecting sections 218 between the first translucent electrode pattern 211 and the second translucent electrode pattern 212. Thus, in the present embodiment, the first translucent electrode patterns 211 are extending in the Y-direction by being connected. On the other hand, the second translucent electrode patterns 212 are disconnected at the intersecting section 218. Also, a translucent insulating film between layers formed by a silicon dioxide film, etc., is formed at the upper layer side of the first translucent electrode pattern 211 and the second translucent electrode pattern 212. On the upper layer of the insulating film between layers, a translucent relay electrode 215, which electrically connects the second translucent electrode patterns 212 that are disconnected at the intersecting section 218, is formed. Accordingly, the second translucent electrode patterns 212 are electrically connected in the X-direction. In the present embodiment, the relay electrode 215 is formed by the second conductive film, such as an ITO film, etc.

The first translucent electrode patterns 211 and the second translucent electrode patterns 212 individually include a diamond-shaped pad section (large area section) having a large area caught between the intersecting sections 218. A connection section positioned at the intersecting section 218 in the first translucent electrode patterns 211 has a narrow-width shape having a narrow width. Also, the relay electrode 215 is also formed to have a narrow-width shape having a narrow width.

On the glass substrate 20, in the outer area of the input surface 10R, wire lines 27a and 27b extending from the first translucent electrode patterns 211 and the second translucent electrode patterns 212, respectively, are formed. The ends of the wire lines 27a and 27b are formed as pads 27c, and wire lines of flexible printed circuit 35 shown in FIG. 1A are electrically connected to the pads 27c.

Configuration of the Input Apparatus 10

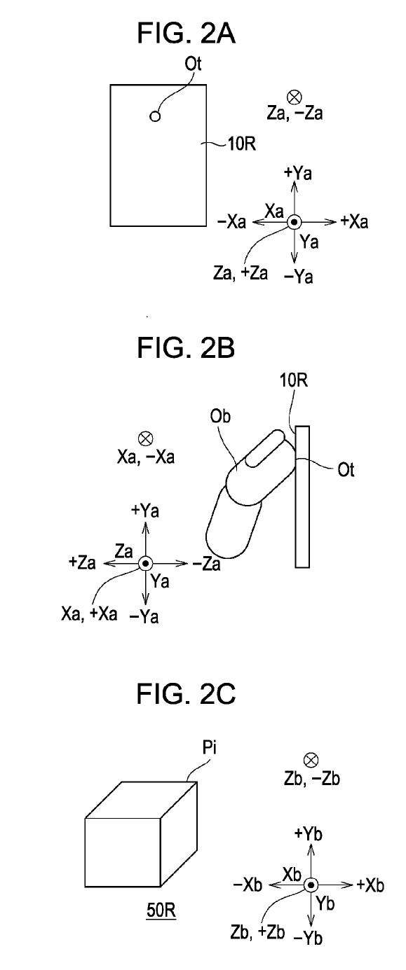

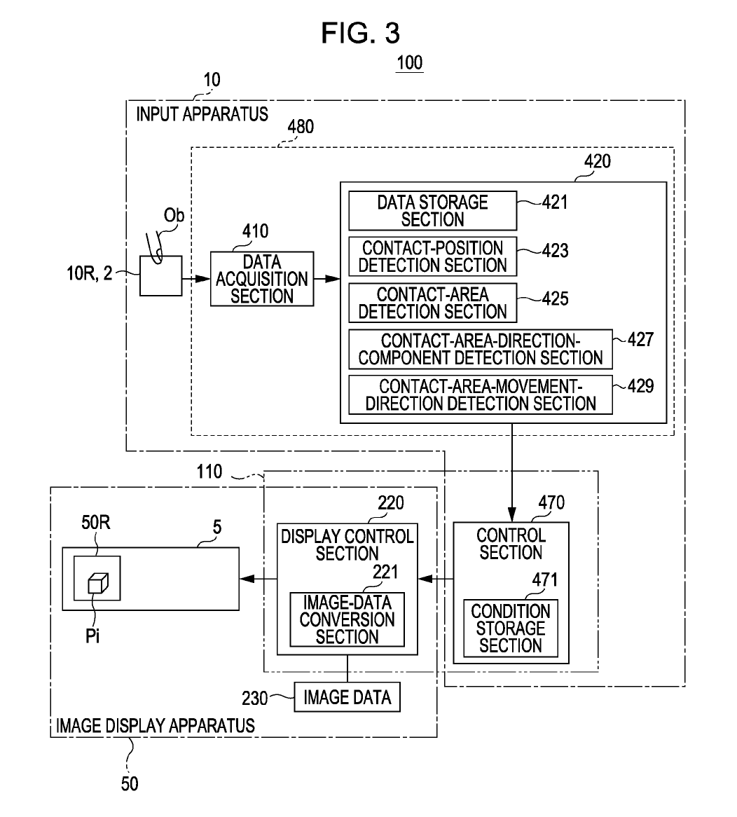

FIG. 2 is an explanatory diagram schematically illustrating a state in which input and image display is carried out in the display apparatus having the input function 100, to which the present application is applied. FIGS. 2A, 2B, and 2C are an explanatory diagram illustrating an area of the input surface 10R that is touched by an object body Ob, such as a finger, etc., an explanatory diagram illustrating a state in which the object body Ob, such as a finger, etc., touches the input surface 10R, and an explanatory diagram schematically illustrating a state in which an image Pi is displayed in the image display area 50R, respectively. FIG. 3 is an explanatory diagram illustrating an electrical configuration of the display apparatus having an input function 100, to which the present application is applied.

In this regard, in FIGS. 2A and 2B, directions perpendicular to each other in a plane on the input surface 10R are denoted by an X-axis direction Xa and a Y-axis direction Ya, and a direction perpendicular to the input surface 10R is denoted by a Z-axis direction Za. Also, in FIGS. 2A and 2B, the right side of the X-axis direction Xa on the drawing is denoted by +Xa, the left side is denoted by −Xa, the up side of the Y-axis direction Ya on the drawing is denoted by +Ya, and the down side is denoted by −Ya, and a direction moving away from the input surface 10R of the Z-axis direction Za is denoted by +Za, and a direction approaching is denoted by −Za. In the present embodiment, the input surface 10R and the image display area 50R are areas that overlap. However, the input surface 10R and the image display area 50R may be formed so as not to overlap. Thus, in FIG. 2C, directions perpendicular to each other in a plane on the image display area 50R are denoted by an X-axis direction Xb and a Y-axis direction Yb, and a direction perpendicular to the image display area 50R is denoted by a Z-axis direction Zb. Also, in FIG. 2C, the right side of the X-axis direction Xb on the drawing is denoted by +Xb, and the left side is denoted by −Xb, the up side of the Y-axis direction Yb on the drawing is denoted by +Yb, the down side is denoted by −Yb, a direction moving away from the image display area 50 (the front side) of the Z-axis direction Zb is denoted by +Zb, and a direction approaching (the back side) is denoted by −Zb.

In the display apparatus having an input function 100 according to the present embodiment, as shown in FIGS. 2A and 2B, a contact state and a change in the contact state at the time when an object body Ob, such as a finger, etc., has touched the input surface 10R is detected. And the detection result is regarded as input information, and as shown in FIG. 2C, an image Pi displayed in the image display area 50R is rotated, etc.

Accordingly, as shown in FIG. 3, in the display apparatus having an input function 100 according to the present embodiment, the input apparatus 10 has a contact-state detection section 480 detecting a contact state and a change in the contact state of an object body Ob, such as a finger, etc., on the input surface 10R and an input-apparatus control section 470 processing the detection result of the contact-state detection section 480. The contact-state detection section 480 outputs the detection result to the input-apparatus control section 470.

More specifically, the contact-state detection section 480 has a data acquisition section 410 which converts a state quantity indicating a state in which an object body Ob, such as a finger, etc., touches the input surface 10R, and a calculation section 420 which obtains a contact position and a contact area by calculation on the basis of the output result from the data acquisition section 410.

Here, the calculation section 420 includes a data storage section 421 which temporarily stores the output result from the data acquisition section 410, and a contact-position detection section 423 which detects the contact position of the object body Ob on the input surface 10R on the basis of the data stored in the data storage section 421 and the output result from the data acquisition section 410. The contact-position detection section 423 generates contact-position information corresponding to such a contact position, and outputs the information to an input-apparatus control section 470.

Also, the calculation section 420 includes a contact-area detection section 425 which detects an area (contact area) of a contact area Ot of the object body Ob on the input surface 10R on the basis of data stored in the data storage section 421 and the output result from the data acquisition section 410. The contact-area detection section 425 generates contact-area information corresponding to the contact area, and outputs the information to the contact-area detection section 425.

In the present embodiment, a contact position is detected by dividing the input surface 10R into small areas and detecting which of the areas have been touched by the object body Ob. Here, the object body Ob touches a plurality of small areas of the divided small areas of the input surface 10R. Accordingly, in the present embodiment, a contact position is detected as a center of the areas touched by the object body Ob. Also, the contact area can be detected by how many small areas of the plurality of small areas of the input surface 10R have been touched by a finger.

In the display apparatus having an input function 100 according to the present embodiment, the calculation section 420 further includes an increase-direction detection section 427 which monitors an increase direction in a contact area when the contact area increases on the basis of the contact-area information generated by the contact-area detection section 425 and the contact-position information detected by the contact-position detection section 423. The increase-direction detection section 427 generates the increase-direction information corresponding to an increase direction in the contact area when the contact area increases, and outputs the information to the input-apparatus control section 470.

Also, the calculation section 420 includes a movement-direction detection section 429 which monitors whether the contact area Ot of the object body on the input surface 10R has moved on the basis of the contact-position information generated by the contact-position detection section 423, and detects the movement direction of the contact area Ot if the contact area Ot has moved. The movement-direction detection section 429 generates the movement-direction information corresponding to the movement direction, and outputs the information to the input apparatus-control section 470.

The input-apparatus control section 470 includes a condition storage section 471 which stores a command instructing an image display condition, etc., in the image display apparatus 50. Such a command corresponds to the information (the contact-position information, the contact-area information, the increase-direction information, and the movement-direction information) output from the contact-state detection section 480. The input-apparatus control section 470, for example, controls the image display apparatus 50 on the basis of the increase-direction information and the movement-direction information to rotate the image Pi currently displayed by the image display area 50R, etc. More specifically, the input-apparatus control section 470 sets the extending direction of the rotational axis Lm at the time of rotating the image Pi on the basis of the increase-direction information. And if determined that the movement direction is a direction intersecting the increase direction on the basis of the movement-direction information, the input-apparatus control section 470 rotates the image Pi about the rotational axis Lm in a direction corresponding to the movement direction. Here, the input-apparatus control section 470 includes a microcomputer, etc., and performs the processing described later on the basis of the program stored in the ROM (not shown in the figure), etc., in advance.

The display apparatus having an input function 100, according to the present embodiment includes a display control section 220 which displays an image corresponding to the image data 230 on the image display apparatus 50. Also, the display control section 220 includes an image-data conversion section 221 which converts the image data 230 on the basis of the command output from the input-apparatus control section 470, and changes the image Pi displayed in the image display area 50R of the image display apparatus 50.

The display apparatus having an input function 100, configured in this manner, rotates the image displayed in the image display area 50R on the basis of the input information of the input apparatus 10. At that time, the input-apparatus control section 470 and the display control section 220 function as the overall control section 110 of the display apparatus having an input function 100.

Input Operation

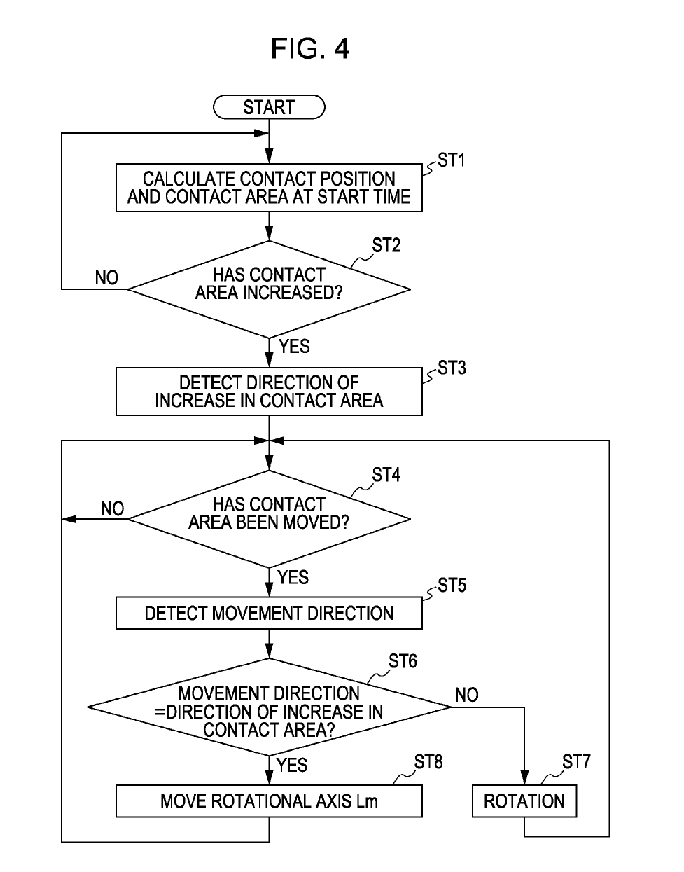

FIG. 4 is a flowchart illustrating control contents at the time of rotating the image Pi by input operation on the input surface 10R in the display apparatus having an input function 100, to which the present application is applied.

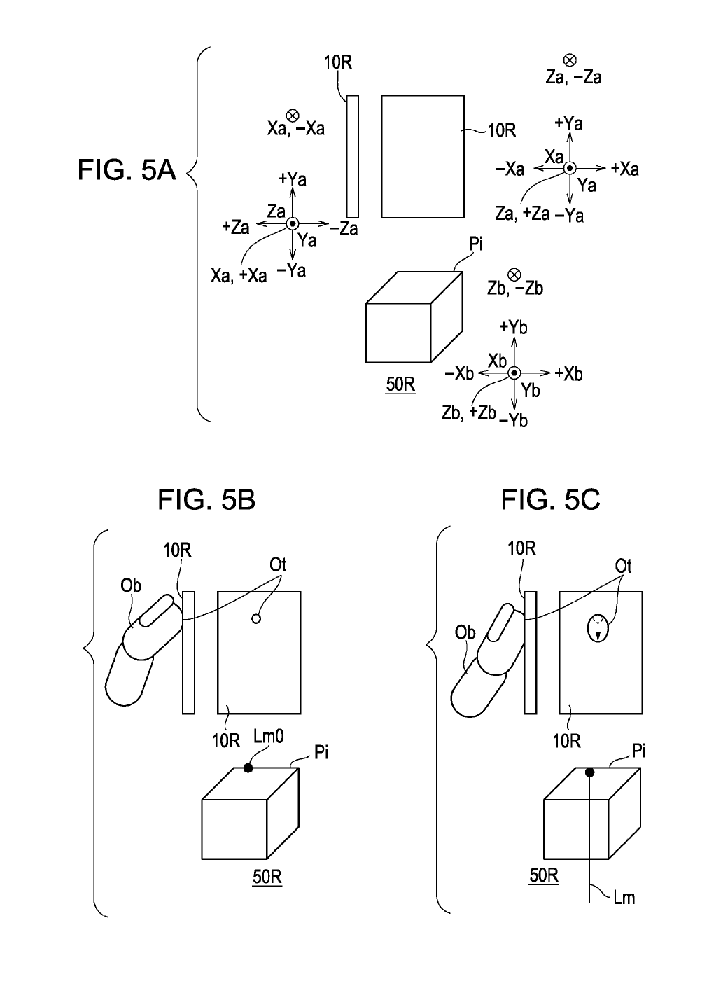

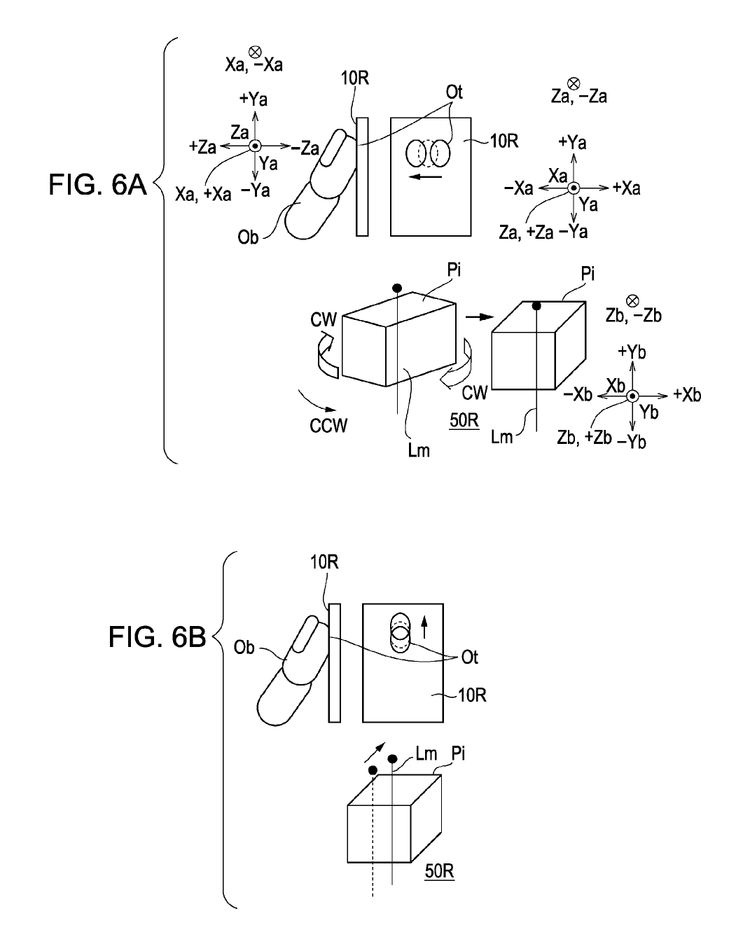

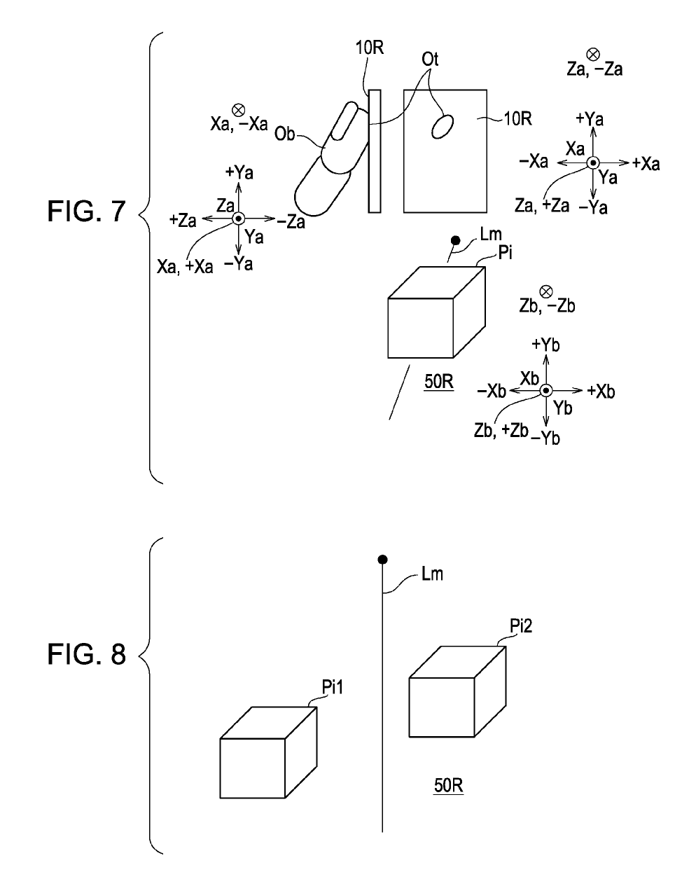

FIGS. 5 and 6 are explanatory diagrams illustrating input operation on the input surface 10R and the image Pi displayed in the image display area 50R in the display apparatus having an input function 100, to which the present application is applied. FIG. 7 is an explanatory diagram in the case where an increase direction of a contact area of the object body Ob on the input surface 10R is inclined in the display apparatus having an input function 100, to which the present application is applied. In this regard, in FIGS. 5A, 5B, and 5C, FIGS. 6A and 6B, and FIG. 7, upper figures are explanatory diagrams illustrating states in which a finger touches the input surface 10R, and lower figures show the image Pi.

In the display apparatus having an input function 100 according to the present embodiment, as shown in FIG. 2, when the object body Ob touches the input surface 10R in a state in which the image Pi is displayed in the image display area 50R, the image Pi is displayed with being rotated. In order to perform such control, in the display apparatus having an input function 100 according to the present embodiment, as shown in FIG. 5A, while the image Pi is displayed, the contact-state detection section 480 monitors whether the object body Ob touches the input surface 10R under the control of the input-apparatus control section 470. And as shown in FIG. 5B, when the object body Ob touches the input surface 10R, the input-apparatus control section 470 performs processing shown in FIG. 4 using the touch as a trigger.

In the processing shown in FIG. 4, first, in step ST1, the contact-position detection section 423 detects a contact position of the object body Ob on the input surface 10R to generate the contact-position information corresponding to the contact position, and outputs the contact-position information to the input-apparatus control section 470. Also, the contact-area detection section 425 detects a contact area of the object body Ob on the input surface 10R to generate the contact-area information corresponding to the contact area, and outputs the contact-area information to the input-apparatus control section 470.

Also, the input-apparatus control section 470 sets a starting point Lm0 of a rotational axis Lm at the time of rotating the image Pi. At this point in time, the input-apparatus control section 470 instructs the display control section 220 to display the starting point Lm0 in the image display area 50R.

Such processing is performed until the contact area increases in determination in step ST2. That is to say, when the object body Ob is pressed on the input surface 10R, the contact area increase. At that time, the contact area increases so as to expand in the direction of the finger extending. Accordingly, it is possible to use the operation of the object body Ob being pressed on the input surface 10R as input. Thus, in step ST2, as, shown in FIG. 5C, when determined that the contact area has increased as a result of the object body Ob having been pressed on the input surface 10R, in step ST3, the increase-direction detection section 427 detects an increase direction of the contact area to generate increase-direction information, and outputs the increase-direction information to the input-apparatus control section 470.

As a result, the input-apparatus control section 470 sets the rotational axis Lm at the time of rotating the image Pi. At that time, the input-apparatus control section 470 sets the rotational axis Lm at a point passing through the display position of the image Pi. More specifically, the rotational axis Lm is set at a position passing through the center of the image Pi. Such a center can be obtained as an intersection point between the center line of the X-axis direction Xb of the image Pi and the center line of the Y-axis direction Yb. At this point in time, the input-apparatus control section 470 instructs the display control section 220 to display the rotational axis Lm in the image display area 50R. Accordingly, the position of the rotational axis Lm can be easily confirmed. In the example shown in FIG. 5C, the increase direction of the contact area is Y-axis direction Ya. Accordingly, the input-apparatus control section 470 sets the rotational axis Lm at a position passing through the display position of the image Pi, and the rotational axis Lm extending in the Y-axis direction Yb is displayed so as to pass through the display position of the image Pi in the image display area 50R.

Next, in step ST4, whether the contact area Ot of the object body Ob on the input surface 10R has moved or not is monitored. In step ST4, if determined that the contact area Ot has moved, in step ST5, the movement-direction detection section 429 detects the movement direction of the contact area Ot to generate movement-direction information, and outputs the movement-direction information to the input-apparatus control section 470.

Next, in step ST6, the input-apparatus control section 470 determined whether the movement direction of the contact area Ot is the same as the increase direction of the contact area. In this determination, if the angle formed by the movement direction of the contact area Ot and the increase direction of the contact area is not greater than a certain value, the movement direction of the contact area Ot and the increase direction of the contact area are regarded as the same. In step ST6, if determined that the movement direction of the contact area Ot and the increase direction of the contact area are different, that is to say, if determined that the movement direction of the contact area Ot intersects the increase direction of the contact area, in step ST7, the input-apparatus control section 470 instructs the display control section 220 to rotate the image Pi about the rotational axis Lm in a direction corresponding to the movement direction of the contact area Ot as shown in FIG. 6A, and then the processing returns to step ST4. In the example shown in FIG. 6A, the contact area Ot moves to the left side −Xa of the X-axis direction Xa so that the image Pi is rotated clockwise CW about the rotational axis Lm. In this regard, if the contact area Ot moves to the right side +Xa of the X-axis direction Xa, the image Pi is rotated counterclockwise CCW about the rotational axis Lm. The rotation angle of the image Pi corresponds to the movement distance of the contact area Ot.

On the other hand, in step ST6, if determined that the movement direction of the contact area Ot and the increase direction of the contact area are the same, in step ST7, the input-apparatus control section 470 moves the position of the rotational axis Lm to the direction corresponding to the movement direction of the contact area Ot in the range of the display position of the image Pi as shown in FIG. 6B, and then the processing returns to step ST4. At that time, the rotational axis Lm after the movement is displayed in the image display area 50R. In the present embodiment, if determined that the movement direction of the contact area Ot and the increase direction of the contact area are the same, the input-apparatus control section 470 moves the position of the rotational axis Lm to the direction corresponding to the Z-axis direction Zb of the image Pi in accordance with the movement direction. In the example shown in FIG. 6B, the contact area Ot has moved to the up side +Ya of the Y-axis direction Ya, and thus the input-apparatus control section 470 moves the position of the rotational axis Lm to the back side (to the back side −Zb of the Z-axis direction Zb) of the image Pi. In this regard, if the contact area Ot has moved to the down side −Ya of the Y-axis direction Ya, the input-apparatus control section 470 moves the position of the rotational axis Lm to the direction corresponding to the front side (to the front side +Zb of the Z-axis direction Zb) of the image Pi. The positional distance of the rotational axis Lm corresponds to the movement distance of the contact area Ot.

Such processing is repeatedly performed while the image Pi is displayed. During that time, if the object body Ob moves away from the input surface 10R, and the contact area of the object body Ob on the input surface 10R becomes not greater than a threshold value, the processing shown in FIG. 4 is suspended. Accordingly, after determined that the contact area has increased in step ST2 and the rotation condition of the image Pi has been set, if the contact area of the object body Ob on the input surface 10R becomes not greater than the threshold value, the rotation condition of the image Pi is reset.

In this regard, in the example shown in FIG. 5C, the increase direction of the contact area is the Y-axis direction Ya so that the rotational axis Lm extending to the Y-axis direction Yb is set. However, for example, as shown in FIG. 7, if the increase direction of the contact area is inclined to the Y-axis direction Ya, the rotational axis Lm extending to the direction inclined to the Y-axis direction Yb is set.

### Main Advantages of the Present Embodiment

As described above, in the display apparatus having an input function 100 according to the present application, when the contact area of an object body Ob on the input surface 10R increases, the input apparatus 10 generates increase-direction information, and when the contact area Ot of the object body Ob on the input surface 10R moves, the input apparatus 10 generates movement-direction information, and thus it is possible to use the increase-direction information and the movement-direction information as input information. Either of such input can be carried out, for example by one finger as the object body Ob, and thus input operation is easy. Accordingly, for example, there is an advantage in that in a state of holding an electronic device equipped with a display apparatus having an input function 100 with one hand, the user is allowed to input with a finger of the hand holding the electronic device, etc.

Also, in the display apparatus having an input function 100 according to an embodiment, the extending direction of the rotational axis Lm at the time of rotating the image Pi is set on the basis of the increase-direction information, and if determined that the movement direction of the contact area Ot intersects the increase direction of the contact area on the basis of the movement-direction information, the image Pi is rotated about the rotational axis Lm in a direction corresponding to the movement direction. Thus, it is possible to rotate the image Pi only by changing a contact state of the object body Ob, such as a finger, etc., on the input surface 10R while watching the image Pi. Accordingly, it is possible to change states, for example, between a state of displaying a front side of a commercial product and a state of displaying a back side of the commercial product by easy operation. Further, the image display apparatus 50 includes the image display area 50R in an area overlapping the input surface 10R as a plane. Accordingly, the user is allowed to perform input operation while watching the image Pi displayed in the image display area 50R.

### Another Embodiment

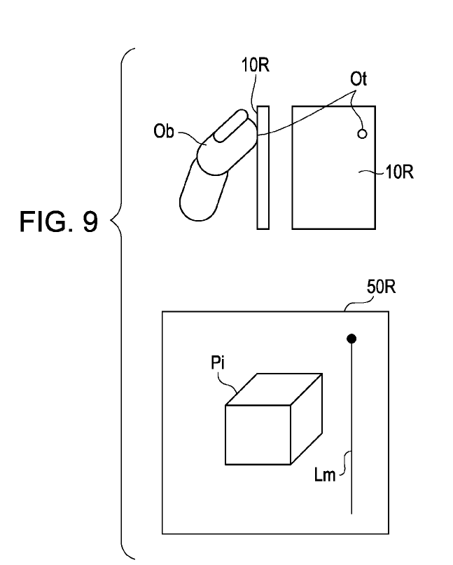

FIG. 8 is an explanatory diagram illustrating another method of setting the rotational axis Lm in the display apparatus having an input function 100, to which the present application is applied. FIG. 9 is an explanatory diagram still another method of setting the rotational axis Lm in the display apparatus having an input function 100, to which the present application is applied.

In the above-described embodiment, wherever the object body Ob touches on the input surface 10R, the rotational axis Lm is set at a position passing through the display position, of the image Pi. However, as shown in FIG. 8, there are cases where two image Pi1 and Pi2 are displayed in the image display area 50R. In these cases, the rotational axis Lm may be set between the two images Pi1 and Pi2. At that time, either of the following methods may be employed. In one of the methods, the two images Pi1 and Pi2 are displayed as they are being rotated together as one unit about the rotational axis Lm. In the other of the methods, the two images Pi1 and Pi2 are rotated about their respective axes that are parallel to the rotational axis Lm at the respective positions. In the case of employing either of the methods, it is advantageously possible to rotate the two images Pi1 and Pi2 at the same time, and to display the images at proper positions.

In this regard, in the above-described embodiment, the starting point Lm0 of the rotational axis Lm is set at the point in time when the object body Ob touches the input surface 10R. However, in the same manner as in the above-described embodiment, if the position of the rotational axis Lm is automatically set in accordance with the positions of the images Pi, Pi1, and Pi2 wherever on the input surface 10R the object body Ob touches, the setting of the starting point Lm0 may be omitted.

In the above-described embodiment, the rotational axis Lm is set at a position passing through the display position of the image Pi wherever on the input surface 10R the object body Ob touches. However, as shown in FIG. 9, even if the image Pi is displayed at the center of the image display area 50R, when the object body Ob touches an end of the input surface 10R, the rotational axis Lm may be set at a position corresponding to that contact position.

### Still Another Embodiment

In the above-described embodiment, the image display apparatus 50 includes the image display area 50R in an area overlapping the input surface 10R as a plane. However, a configuration in which the input surface 10R and the image display area 50R are disposed in different area may be employed. For example, the electro-optical panel 5 of the image display apparatus 50 may be disposed at an opposed position to the user on a desk, and the input panel 2 of the input apparatus 10 may be disposed on a desk beside the user. With this arrangement, the input apparatus 10 can be used as an input-dedicated apparatus, such as a mouse, for example, separately from the image display apparatus 50.

Also, an image displayed by the image display apparatus 50 is not limited to a two-dimensional image, but may be a three-dimensional image (3D image/stereographic image).

Further, for the input apparatus 10, as long as a contact area of the input surface 10R can be detected, a touch panel is not only limited to a capacitive type, but also an optical type, an electro-magnetic induction type, etc., may be used. Further, the image display apparatus 50 is not only limited to a liquid-crystal display apparatus, and a display apparatus, such as an electro-luminescence apparatus, etc., may be used.

Example of Installation on Electronic Device

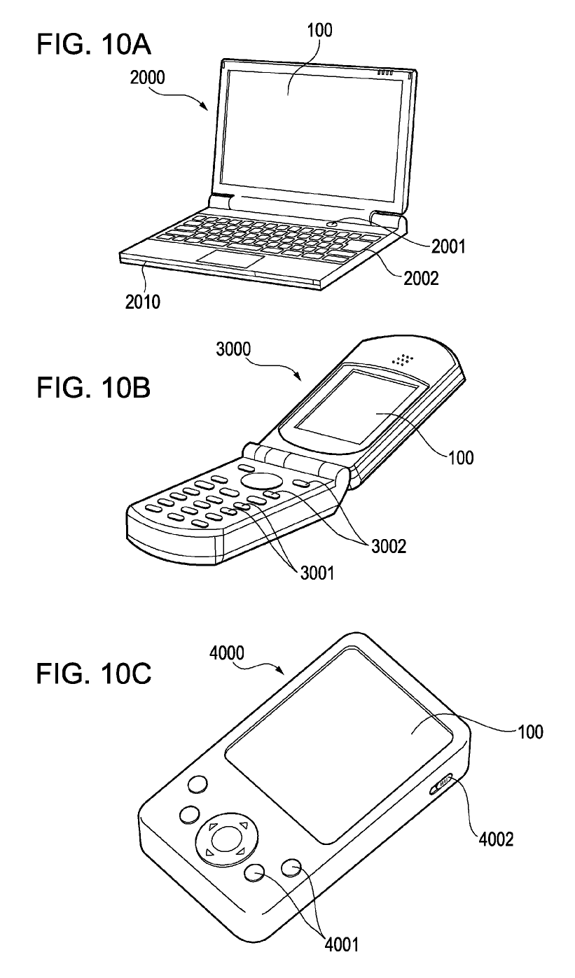

A description will be given of an electronic device to which the display apparatus having an input function 100 is applied. FIG. 10A illustrates a configuration of a mobile personal computer equipped with the display apparatus having an input function 100. The personal computer 2000 includes the display apparatus having an input function 100 as a display unit and a main unit 2010. The main unit 2010 is provided with a power switch 2001 and a keyboard 2002. FIG. 10B illustrates a configuration of a mobile telephone including the display apparatus having an input function 100. The mobile telephone 3000 includes a plurality of operation buttons 3001, a scroll button 3002, and a display apparatus having an input function 100 as a display unit. By operating the scroll button 3002, a screen displayed on the display apparatus having an input function 100 is scrolled. FIG. 10C illustrates a configuration of personal digital assistants to which the display apparatus having an input function 100 is applied. The personal digital assistants 4000 includes a plurality of operation buttons 4001, a power switch 4002, and a display apparatus having an input function 100 as a display unit. By operating the power switch 4002, various kinds of information, such as an address book, an appointment book, etc., are displayed on the display apparatus having an input function 100.

In this regard, the electronic devices to which the display apparatus having an input function 100 is applied include a digital still camera, a liquid-crystal television, a view-finder type and a monitor-direct-view type video recorders, a car navigation apparatus, a pager, an electronic diary, a calculator, a word processor, a workstation, a television telephone, a POS terminal, a banking terminal, etc., in addition to the devices shown in FIG. 10. And the above-described display apparatus having an input function 100 can be applied to a display section of these various kinds of electronic devices.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An input apparatus having an input surface touched by an object body at input time, the input apparatus comprising:
when a contact area of the object body on the input surface increases, an increase-direction detection section generating increase-direction information corresponding to the increase direction of the contact area; and
when the contact area of the object body on the input surface is moved, a movement-direction detection section generating movement-direction information corresponding to the movement direction of the contact area.

2. A display apparatus having an input function, comprising:
an input apparatus having an input surface touched by an object body at input time, the input apparatus comprising;
when a contact area of the object body on the input surface increases, an increase-direction detection section generating increase-direction information corresponding to the increase direction of the contact area;
when the contact area of the object body on the input surface is moved, a movement-direction detection section generating movement-direction information corresponding to the movement direction of the contact area;
an image display apparatus displaying an image in an image display area;
a control section controlling the image display apparatus on the basis of the increase-direction information and the movement-direction information to rotate the image currently displayed in the image display area; and
wherein the control section sets an extending direction of a rotational axis at the time of rotating the image on the basis of the increase-direction information, and if determined that the movement direction intersects the increase direction on the basis of the movement-direction information, the control section rotates the image about the rotational axis in a direction corresponding to the movement direction.

3. The display apparatus having an input function, according to claim 2,
wherein the image display apparatus includes the image display area in an area overlapping the input surface as a plane.

4. The display apparatus having an input function, according to claim 2,
wherein when the control section determines that the movement direction is the same as the increase direction in the movement-direction information, the control section moves the rotational axis to a position corresponding to the movement direction in a direction intersecting the rotational axis.

5. The display apparatus having an input function, according to claim 2,
wherein the input apparatus includes a contact-area detection section detecting a contact area of the object body on the input surface, and generating contact-area information corresponding to the contact area, and
the control section resets a rotational condition of the image if the contact area is not larger than a threshold value after the contact area increases.

6. The display apparatus having an input function, according to claim 2,
wherein the image display apparatus displays the rotational axis determined by the control section in the image display area.

7. The display apparatus having an input function, according to claim 2,
wherein when setting the rotational axis on the basis of the increase-direction information, the control section sets the rotational axis at a position passing through the image.

8. The display apparatus having an input function, according to claim 2,
wherein when setting the rotational axis on the basis of the increase-direction information, if two of the images are displayed in the image display area, the control section sets the rotational axis at a center of the two images.

9. The display apparatus having an input function, according to claim 2,
wherein the input apparatus includes a contact-position detection section detecting a contact position of the object body on the input surface, and generating contact-position information corresponding to the contact position, and
when setting the rotational axis on the basis of the increase-direction information, the control section sets the rotational axis at a position corresponding to the contact position.

10. A method of inputting in an input apparatus having an input surface touched by an object body at input time, the method comprising:
when a contact area of the object body on the input surface increases, generating increase-direction information corresponding to the increase direction of the contact area; and
when a contact area of the object body on the input surface is moved, generating movement-direction information corresponding to the movement direction of the contact area.

11. A method of controlling a display apparatus having an input function changing a display mode of the image on the basis of the method of inputting according to claim 10,
wherein an extending direction of a rotational axis at the time of rotating the image is set on the basis of the increase-direction information, and if determined that the movement direction intersects the increase direction of the contact area in the movement-direction information, the image is rotated about the rotational axis in a direction corresponding to the movement direction.
